(19) United States
(12) Patent Application Publication
(10) Pub. No.: US 2015/0281596 A1
(43) Pub. Date: Oct. 1, 2015

(54) SYNTHETIC VISION AND VIDEO IMAGE BLENDING SYSTEM AND METHOD

(71) Applicant: Dynon Avionics, Inc., Woodinville, WA (US)

(72) Inventor: Eric Edward Reed, Everett, WA (US)

(21) Appl. No.: 14/676,746

(22) Filed: Apr. 1, 2015

Related U.S. Application Data
(60) Provisional application No. 61/973,773, filed on Apr. 1, 2014.

(51) Int. Cl. H04N 5/265; H04N 5/232

(52) U.S. Cl. CPC H04N 5/265; H04N 5/23229

(57) ABSTRACT

Embodiments of the invention provide a system and method of image blending display system that includes a non-transitory computer-readable medium in data communication with at least one processor, one or more processors coupled to a database system, and configured to process information from the non-transitory computer-readable medium and from a sensor interface and an image stream interface. A blended vision processor can receive a synthetic image from a synthetic image generator, and a video image from a video capture and processor in communication with the blended vision processor, and calculate a blended image based at least in part on the synthetic image and the video image. In some embodiments, blended image includes a destination color, D, where D is computed as (1-A)×S₁+A×S₂, and where S₁ and S₂ are given source colors and A is a blending factor.

### RELATED APPLICATIONS

This application claims priority from U.S. Provisional Application No. 61/973,773, filed on Apr. 1, 2014, the entire contents of which are incorporated herein by reference.

### BACKGROUND

Devices exist today which display computer-generated imagery of the environment around a person or vehicle. These images can be generated in a variety of ways. The images can be stored photographs, a database of information that the computer processes to generate an image, or guaranteed by other methods. These images are often based on the location and situation of the person or vehicle, including direction, attitude, and altitude. The general purpose of these images is to provide an image to the user that is enhanced over what could be seen with the naked eye from that location.

In aviation, the technology which produces these images is called “Synthetic Vision.” Synthetic vision technologies store a database of physical terrain elevations versus locations in a non-transient storage medium. A computer processor generates an image of terrain for display. This image is generally designed to emulate what the pilot would see out the window if there were no obstructions or obscuring conditions. Thus, in environments where standard human vision is obscured, such when flying through fog, the pilot can use the synthetic vision display to fly the aircraft and avoid obstacles.

Further, synthetic vision can also include data more than just terrain, such as water bodies, runways, man-made obstacles, weather, other aircraft, and more. Synthetic vision can or cannot be manipulated by other information, to better represent the image the pilot would see via direct vision. Because the pilot is in a moving vehicle, the synthetic vision image can also represent pitch, roll, heading, or other data.

Video capture devices have also been used to assist pilots flying aircraft. In the simple form, these take visible light and convert it to an electrical signal for storage or display. Some video capture devices can also capture images that a human cannot see un-assisted, such as a night-vision camera or an infrared camera which measures the heat of an object instead of reflected light.

It is common in various industries for a display device to be capable of showing images from a variety of sources. In the most common form, a desktop computer can show a video game, an internet video, or an image from a webcam. These images are shown independent of one another, and the user can manually select which one they wish to view, or can choose to view them side by side.

Some avionics systems will display basic information on top of video, such as airspeed, altitude, or a display of an attitude line. These displays are typically placed on top of the video image, blocking those areas of the video.

Some avionics systems perform the task of calculating and displaying synthetic vision, as well as taking an electronic video input and displaying that. They allow the pilot to select between showing synthetic vision, video, or putting the two side by side. While helpful, these systems can distract a pilot by requiring the display to be switched and also requiring the pilot to attempt to determine which display is helpful on an ongoing basis.

### SUMMARY

Some embodiments of the invention include an image blending display system comprising at least one sensor interface configured to receive position information from at least one physical position sensor, and at least one image stream interface configured to receive image data from at least one physical image sensor. The image blending display system comprises a non-transitory computer-readable medium in data communication with at least one processor, where the non-transitory computer-readable medium includes a database system, one or more processors coupled to the database system, and is configured to process information from the non-transitory computer-readable medium and from at least one other information source. The at least one other information source comprises the at least one sensor interface and the at least one image stream interface. Further, the image blending display system comprises a blended vision processor, a synthetic image generator in communication with the database system, the at least one sensor interface, and the blended vision processor. Furthermore, the synthetic image generator is configured to deliver at least one synthetic image to the blended vision processor. The image blending display system comprises a video capture and processor in communication with the blended vision processor that is configured to image process at least one synthetic image delivered by the synthetic image processor, and at least one image from the video capture and processor to produce at least one blended image for the display based at least in part on the at least one synthetic image and the at least one image.

In some embodiments, the database system comprises a terrain/water database. In some further embodiments, the database system comprises a feature database. In some embodiments of the invention, the at least one physical sensor comprises a GPS sensor. In some embodiments, the at least one physical position sensor comprises at least one of an altitude sensor, a speed sensor, and a heading sensor. In some embodiments, the at least one physical image sensor comprises a physical optical sensor. In some further embodiments, the at least one physical image sensor comprises a camera. In some embodiments, the position information is derived from at least one of a GPS signal and an external force. In some embodiments, the video capture and processor is configured to deliver image data based at least in part on detectable energy. In some embodiments, the blended video processor is coupled to one or more user displays.

In some embodiments, the one or more processors of the image blending display system can couple to at least one sensor interface and to receive positional information from at least one physical position sensor. The one or more processors of the image blending display system can couple to at least one image stream interface and to receive image data from at least one physical image sensor. The one or more processors of the image blending display system can couple to and process information from a database system and from at least one other information source, where the at least one other information source comprises the at least one sensor interface and the at least one image stream interface. Further, the one or more processors of the image blending display system can process at least one synthetic image using a synthetic image generator using a synthetic image generator in communication with the database system, the at least one sensor interface, and a blended vision processor. The one or more processors of the image blending display system can process a delivery of at least one synthetic image to the blended vision processor, and using a video capture and processor video capture, process at least one image from the and at least one image stream interface, where the video capture and processor video capture is communicatively coupled to the blended vision processor. Further, using the blended vision processor, the one or more processors of the image blending display system can process and display at least one blended image based at least in part on the at least one image and the at least one synthetic image.

In some embodiments, the blended vision processor is configured to process image data by calculation of a destination color, D, where D is computed as (1-A)×S₁+A×S₂, where S₁ and S₂ are given source colors and A is a blending factor. Further, in some embodiments, the one or more processors of the image blending display system can process image data by calculation of a destination color, D, where D is computed as (1-A)×S₁+A×S₂, where S₁ and S₂ are given source colors and A is a blending factor. Therefore, in some embodiments, the blended image comprises destination color, D, where D is computed as (1-A)×S₁+A×S₂, where S₁ and S₂ are given source colors and A is a blending factor.

Some embodiments include a computer-implemented method of displaying a blended image comprising providing a non-transitory computer-readable medium in data communication with at least one processor, where the non-transitory computer-readable medium includes software instructions comprising a synthetic vision and video image blending system and method. The computer-implemented method includes providing one or more processors configured to execute the steps of the method comprising coupling to at least one sensor interface and receiving positional information from at least one physical position sensor, and coupling to at least one image stream interface and receiving image data from at least one physical image sensor. The method includes coupling to and processing information from a database system and from at least one other information source, where the at least one other information source comprises the at least one sensor interface and the at least one image stream interface. Further, the method includes processing at least one synthetic image using a synthetic image generator, the at least one synthetic image generator in communication with the database system, the at least one sensor interface, and a blended vision processor. The method further includes processing a delivery of at least one synthetic image to the blended vision processor, and using a video capture and processor video capture, processing at least one image from the and at least one image stream interface, where the video capture and processor video capture is communicatively coupled to the blended vision processor. The method also includes using the blended vision processor to process and display at least one blended image based at least in part on the at least one image and the at least one synthetic image, where the at least one blended image comprises a destination color, D, where D is computed as (1-A)×S₁+A×S₂, and where S₁ and S₂ are given source colors and A is a blending factor.

### DESCRIPTION OF THE DRAWINGS

FIG. 1A is a system diagram of intelligent digital image blending from multiple image sources according to one embodiment of the invention.

FIG. 1B shows a computer system configured to operate at least a portion of the system of FIG. 1A according to some embodiments of the invention.

FIG. 2A illustrates a synthetic vision image according to one embodiment of the invention.

FIG. 2B illustrates a blended image showing gradations of blend between the synthetic vision of FIG. 2A and the video images of FIG. 2C according to one embodiment of the invention.

FIG. 2C illustrates a video image according to one embodiment of the invention.

FIG. 3A illustrates a synthetic vision image according to one embodiment of the invention.

FIG. 3B illustrates a blended image showing gradations of blend between the synthetic vision of FIG. 3A and the video images of FIG. 3C according to one embodiment of the invention.

FIG. 3C illustrates a video image according to one embodiment of the invention.

FIG. 4A illustrates a synthetic vision image according to one embodiment of the invention.

FIG. 4B illustrates a blended image showing gradations of blend between the synthetic vision of FIG. 4A and the video images of FIG. 4C according to one embodiment of the invention.

FIG. 4C illustrates a video image according to one embodiment of the invention. FIG. 2A illustrates a synthetic vision image according to one embodiment of the invention.

FIG. 5A illustrates a synthetic vision image according to one embodiment of the invention.

FIG. 5B illustrates a blended image showing gradations of blend between the synthetic vision of FIG. 5A and the video images of FIG. 5C according to one embodiment of the invention.

FIG. 5C illustrates a video image according to one embodiment of the invention.

FIG. 6A illustrates a synthetic vision image according to one embodiment of the invention.

FIG. 6B illustrates a blended image showing gradations of blend between the synthetic vision of FIG. 6A and the video images of FIG. 6C according to one embodiment of the invention.

FIG. 6C illustrates a video image according to one embodiment of the invention.

FIG. 7A illustrates a synthetic vision image according to one embodiment of the invention.

FIG. 7B illustrates a blended image showing gradations of blend between the synthetic vision of FIG. 7A and the video images of FIG. 7C according to one embodiment of the invention.

FIG. 7C illustrates a video image according to one embodiment of the invention.

FIG. 8A illustrates a synthetic vision image according to one embodiment of the invention.

FIG. 8B illustrates a blended image showing gradations of blend between the synthetic vision of FIG. 8A and the video images of FIG. 8C according to one embodiment of the invention.

FIG. 8C illustrates a video image according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Moreover, the figures disclosed and described herein represent high-level visualizations. Those of ordinary skill in the art will appreciate that each figure is presented for explanation only and does not include each and every decision, function, and feature that can be implemented. Likewise, the figures and related discussions are not intended to imply that each and every illustrated decision, function, and feature is required or even optimal to achieve the disclosed desired results.

Some embodiments of the invention focus on an innovative blending of synthetic vision and video from one or more video capture devices. While synthetic vision is useful when a pilot has no visual reference, a pilot generally has to switch to visual references prior to landing. Intelligently and automatically blending the video input with synthetic vision can provide a pilot greater awareness when visual references are available without the need to look away from the primary flight instruments or manually request the instrument switch the view.

Some embodiments of the system can take two or more sources of images (e.g. synthetic vision, video from different cameras, sensor input, or the like) and intelligently combine these images using a process that prioritizes the most useful image. In some embodiments of the invention, this prioritization is done on a per-pixel basis, so that each area of the screen has the most useful data possible. In some other embodiments of the invention, the prioritization is accomplished on a multiple pixel basis.

Some embodiments of the invention provide individuals with enhanced vision. For example, night vision devices can be provided with additional video or sensor inputs, and some embodiments of the invention can provide similar intelligent blending techniques as have been previously described herein. Some embodiments of the invention provide a pilot of a water-based vehicle with enhanced vision. Water can provide a substantially uniform background that is similar to the sky, and contrast with the water suggests possibly useful visual content. Some further embodiments of the invention provide a driver of a land-based vehicle with enhanced vision similar intelligent blending techniques as have been previously described herein. In environments which have frequently varying inhomogeneity, contrast with background structures and analysis of moving objects in the environment can be provided as inputs to determine desirable, intelligent blending techniques.

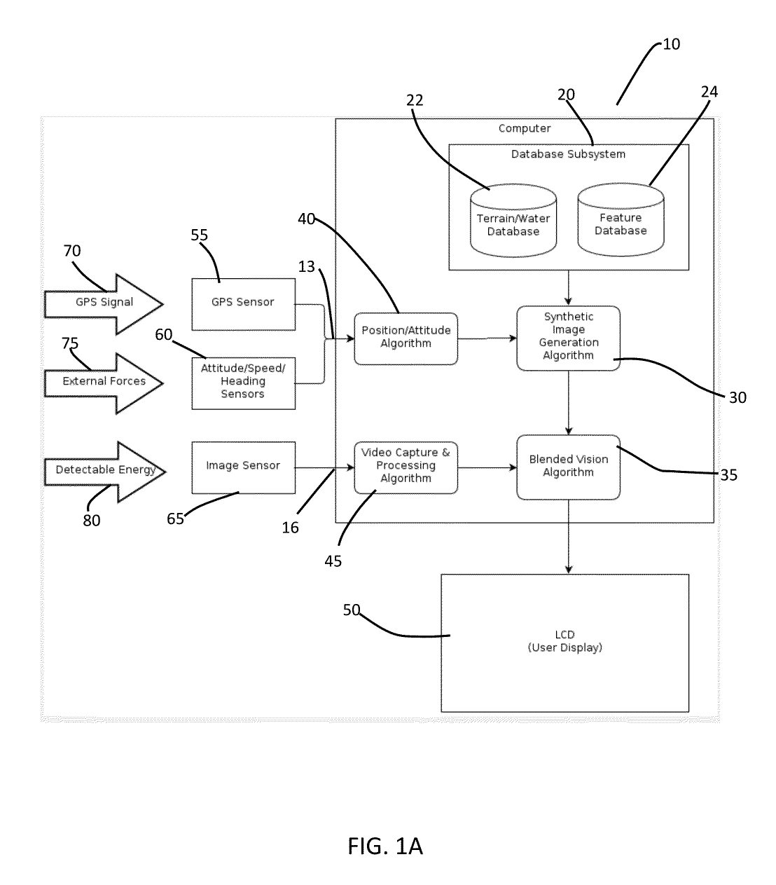

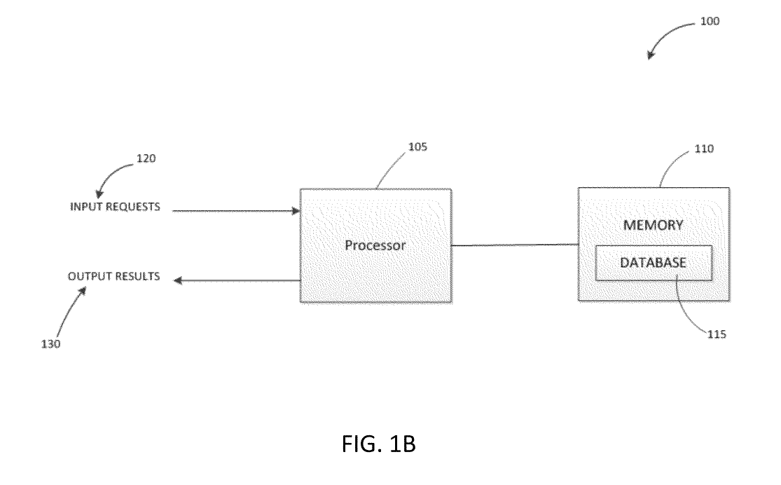

FIG. 1A shows one example of a system architecture 10 that, in some embodiments, can be used to implement a synthetic vision and video image blending system and method including at least one of the methods described herein. The system architecture 10 can include at least one computing device, including at least one or more processors. Further, FIG. 1B shows a block diagram of a system 100 implementing a synthetic vision and video image blending system and method within the system architecture 10 shown in FIG. 1A. In some embodiments of the invention, the system 100 includes a processor 105 coupled with a memory 110, and where the memory 110 can be configured to store data. In some embodiments, the processor 105 can be configured to interface or otherwise communicate with the memory 110, for example, via electrical signals propagated along a conductive trace or wire. In an alternative embodiment, the processor 105 can interface with the memory 110 via a wireless connection. In some embodiments, the memory 110 can include a database 115. The database 115 can include a plurality of data or entries stored in the database 115 of the memory 110.

As discussed in greater detail herein, in some embodiments, the processor 105 can be tasked with executing software or other logical instructions to enable the synthetic vision and video image blending system and method to function as desired. In some embodiments, input requests 120 can be received by the processor 105 (e.g., via signals transmitted to the processor 105 via a network or internet connection), and one or more calculations can output data based on the input requests 120. In some embodiments, the input requests 120 can comprise data from one or more external data sources. In an alternative embodiment, the input requests 120 can be received by the processor 105 via a user input device that is not at a geographically remote location (e.g., via a connected keyboard, mouse, etc. at a local computer terminal).

In some embodiments, after performing tasks or instructions based upon the user input requests 120 (e.g., looking up information or data stored in the memory 110), the processor 105 can output results 130 back to the user that can be based at least in part on one or more input requests 120. In some embodiments, the processor 105 can include at least one processor residing and functioning in one or more server platforms. Further, in some embodiments, the system architecture 10 can include a network and application interface coupled to a plurality of processors running at least one operating system, coupled to at least one data storage device, a plurality of data sources, and at least one input/output device. Some embodiments include at least one computer readable medium. In some embodiments, the at least one computer medium can comprise a database (such as database 115). In some embodiments, the database 115 can comprise a data system 20 including one or more databases. For example, in some embodiments, the system architecture 10 can include a database system 20 comprising a terrain/water database 22 and/or or feature database 24.

In some embodiments, the system architecture 10 (e.g., using the system 100 as described) can enable one or more users to receive, analyze, input, modify, create and send data to and from the system architecture 10, including to and from one or more enterprise applications running on the system architecture 10, and/or to a computer network. In some embodiments, the network can include wide area networks (WAN's), direct connections, such as through a universal serial bus (USB) port, other forms of computer-readable media, or any combination thereof. Also, various other forms of computer-readable media can transmit or carry instructions to a computer, including a router, private or public network, or other transmission device or channel, both wired and wireless. In some embodiments, one or more components of the network can be user devices which can be aircraft display systems, and/or networked or personal computers. In general, a user device can be any type of external or internal devices such as one or more displays (e.g., LCD user display 50), one or more flight displays and/or cockpit displays such as a head-up display and/or a primary flight display, one or more flight controls and/or cockpit controls, a mouse or joy-stick, a keyboard, a CD-ROM, DVD, or other input or output devices. In other embodiments, one or more components of the network can be user devices such as digital assistants, personal digital assistants, cellular phones, mobile phones, smart phones, pagers, digital tablets, laptop computers, Internet appliances, and other processor-based devices.

In some embodiments of the invention, the system architecture 10 can be used to implement a synthetic vision and video image blending system and method to display a plurality of outputs based at least in part on one or more data sources. In some embodiments, data or information can be received into the system architecture 10 using one or more interfaces. For example, in some embodiments, positional information can be received into the system architecture 10 through at least one sensor data interface 13 from at least one physical sensor. In some further embodiments, image information can be received into the system architecture 10 through at least one image stream interface 16. For example, in some embodiments, the system architecture 10 can receive signals from at least one physical sensor such as at least one global positioning system satellite signal (hereinafter “GPS”) sensor 55 coupled to at least one sensor data interface 13. In some further embodiments, the system architecture 10 can receive signals from other physical sensors such as from at least one altitude sensor, speed sensor, and/or heading sensor (marked as sensor 60 where sensor 60 can be any one or all of an altitude sensor, a speed sensor, and/or a heading sensor) coupled to at least one sensor data interface 13. Further, in some other embodiments, the system architecture 10 can receive signals (e.g., video signals or data) from at least one physical image sensor 65 coupled to at least one image stream interface 16. Further, in some embodiments, signals including or comprising data or information can be received by the processor 105 based on at least one GPS signal 70. In some further embodiments, signals including or comprising data or information can be received by the processor 105 based on at least one external force 75. Further, in some other embodiments, signals including or comprising data or information can be received by the processor 105 based, at least in part, on one other detectable energy 80.

In some embodiments, the system architecture 10 can import position information from an onboard navigation instrument such as GPS sensor 55 (e.g., an onboard GPS receiver). Navigation information, i.e., heading, elevation, current position and ground speed information, can be retrieved and used to determine an aircraft's current position and altitude. In some embodiments, a flight plan can be retrieved from an onboard flight management system and used to retrieve the relevant airport information, and can include local terrain data and obstacles to flight. The GPS information received from the GPS sensor 55 can also be used to determine the aircraft's position with respect to an airport, including for example runway position and direction. Further, the aircraft's position and speed with respect to the ground can comprise information retrieved from one or more altitude and/or combined altitude and height-above-ground sensors and one or more airspeed sensors.

In some embodiments, the system architecture 10 can include at least one physical image sensor 65 configured to be sensitive to detectable energy 80. For example, in some embodiments, the system architecture 10 can include at least one physical image sensor 65 comprising a camera or other physical optical sensor. The systems and methods of the invention need not be limited to a single camera or physical optical sensor. For example, in some embodiments, the system architecture 10 can include at least one physical image sensor 65 comprised of a plurality of individual and/or networked cameras. Some embodiments of the invention can utilize different camera technologies such as visual spectrum and infrared sensitive cameras or physical optical sensors. For example, in some embodiments, the system architecture 10 can include at least one physical image sensor 65 comprising a camera configured to be sensitive to incoming visible light, incoming infra-red radiation, or both. Furthermore, some embodiments can also utilize cameras with varying orientations to create a larger composited image.

In some embodiments of the invention, information from the GPS sensor 55 and/or altitude/speed/heading sensors can be received and processed by one or more software instructions of the synthetic vision and video image blending system and method using the system architecture 10 (e.g., position/altitude processor 40). Further, in some embodiments, video image data from the image sensor 65 can be received and processed by one or more software instructions of the synthetic vision and video image blending system and method using the system architecture 10 (e.g., video capture and processor 45).

In some embodiments, information from at least one of the position/altitude processor 40 and database system 20 (e.g., from at least one of the terrain/water database 22 and feature database 24) can be processed by the system architecture 10 using a synthetic image generator 30 to produce one or more synthetic images based at least in part on one or more GPS signals 70 and/or external forces 75.

Some embodiments of the invention provide a unique technique to blend synthetic vision with video. The blending factor is based on several inputs and calculated for a plurality of regions within the video image, where higher contrast with the luminosity of the sky results in a greater percentage of the video image being shown. Contrast with the sky suggests visual content that can be more useful. For example, in some embodiments of the invention, a blended vision processor 35 can receive and process at least one synthetic image from the synthetic image generator 30 and at least one video image from the video capture and processor 45 to produce at least one blended image. Further, in some embodiments, at least one blended image can be output to the user display 50.

In some embodiments, higher contrast sampled within a region can result in a greater percentage of the video image being shown. Further, in some embodiments, contrast within a region suggests visual details can be visible. In some embodiments, higher color saturation within a region can result in a greater percentage of the video image being shown.

In aircraft applications, clouds often obscure only parts of the field of view. Some embodiments of the invention allow synthetic vision or alternate cameras to fill in those areas without requiring the whole image to switch to the alternate system. In some embodiments, the video image is substantially aligned with synthetic vision through utilization of a calibration procedure that adjusts for camera orientation and field of view. Clouds generally have no color saturation, so any color suggests possibly useful visual content. In some embodiments, other inputs into the blending factor calculation can be selected based on the particular application.

In some embodiments of the invention, an alpha blending equation is used to blend at least a portion of a video image or video data with a synthetic image or data. For example, given source colors, S₁ and S₂, and a blending factor, A, the destination color, D, can be computed as:

D=(1-A)×S₁+A×S₂

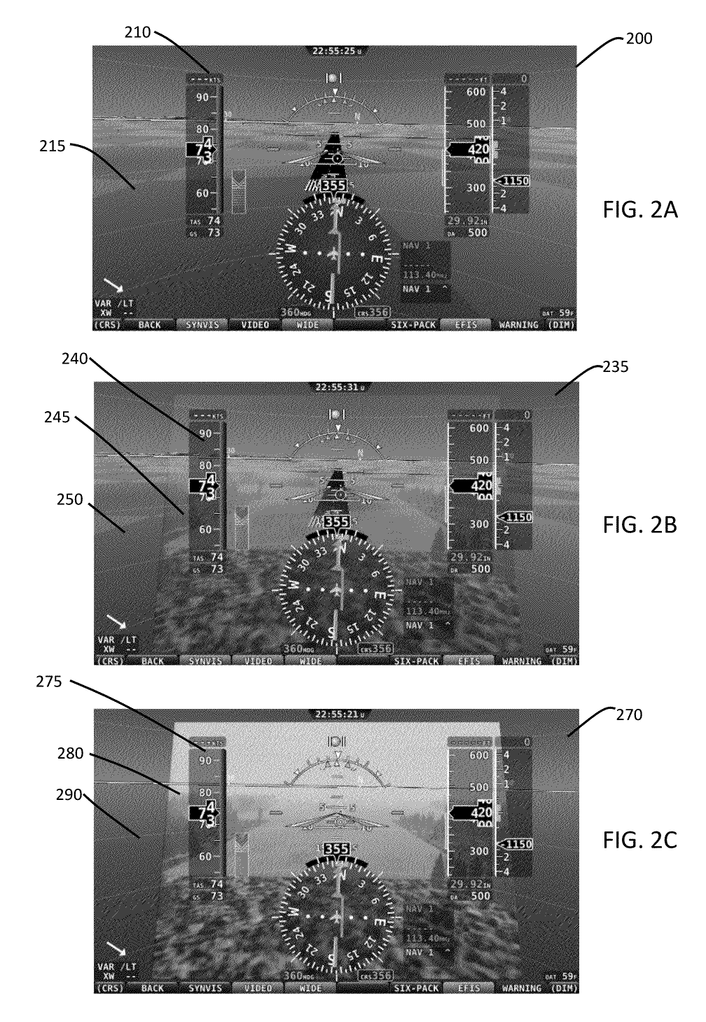

In some embodiments, the destination color, D, can be used to form and display at least a portion of a blended image that comprises information derived from source colors S₁ and S₂. In some embodiments of the invention, the system architecture 10 can be used to implement a synthetic vision and video image blending system and method to display blended images comprising destination colors D based at least in part on a plurality of data sources. For example, in some embodiments, any one of the blended images shown in synthetic vision images 200, 300, 400, 500, 600, 700, 800 shown in FIGS. 2B, 3B, 4B, 5B, 6B, 7B, and 8B respectively can comprise destination colors D (i.e., pixels comprising one or more destination colors D) calculated by the system architecture 10 through at least one implementation of the synthetic vision and video image blending system and method described above. More specifically, in some embodiments, any of the blended image regions 245, 345, 445, 545, 645, 745, 845, 945 shown in FIGS. 2B, 3B, 4B, 5B, 6B, 7B, and 8B respectively can comprises pixels with one or more destination colors D.

FIG. 2A illustrates a synthetic vision image 200 according to one embodiment of the invention. Further, FIG. 2B illustrates a blended image 235 showing gradations of blend between the synthetic vision image 200 of FIG. 2A and the video image 270 of FIG. 2C, where FIG. 2C illustrates a video image 270 of an outside environment according to one embodiment of the invention. In some embodiments, the system architecture 10 can display the video image 270 from data captured by the at least one physical image sensor 65 sensitive to detectable energy 80. The video image 270 can comprise a video image display data 280 displayed over a background 290, and at least one blended instrument display 275 blended with the video image display data 280 displayed and the background 290. Further, information from at least one of the position/altitude processor 40, at least one terrain/water database 22 and/or feature database 24 can be processed by the system architecture 10 using a synthetic image generator 30 to produce a synthetic image 200 based at least in part on one or more GPS signals 70 and/or external forces 75. In some embodiments, the synthetic image 200 can comprise a synthetic environment image 215 depicting a representation of the outside world with at least one blended instrument display 210. In some embodiments of the invention, the blended vision processor 35 can receive and process the synthetic image 200 from the synthetic image generator 30, and the video image 270 from the video capture and processor 45 to produce the blended image 235. Therefore, the blended image 235 can comprise a blend of the synthetic image 200 and the video image 270. The blended image 235 can comprise a blended image region 245 at least partially surrounded by a synthetic image portion 250 derived from the synthetic environment image 215. Further, the blended image region 245 can comprise the at least one blended instrument display 240 derived from blending the blended video image display data 280 with either the at least one blended instrument display 210 or the at least one blended instrument display 275. In some embodiments, the blended image 235 can be displayed on at least one user display 50 such as an LCD or CRT.

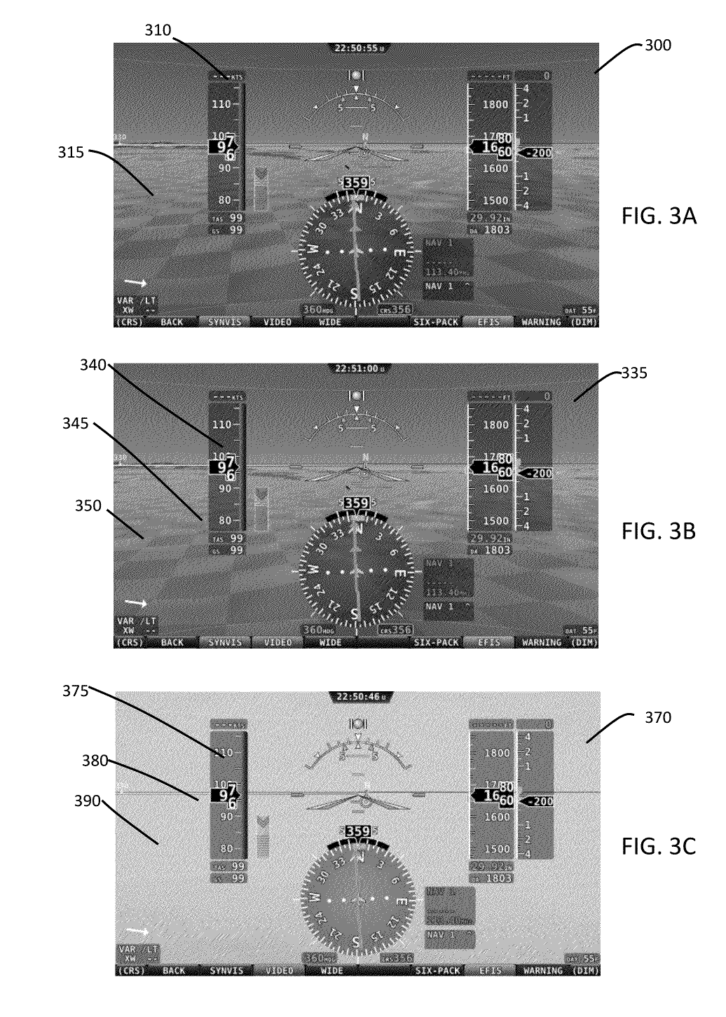

FIG. 3A illustrates a synthetic vision image 300 according to one embodiment of the invention. Further, FIG. 3B illustrates a blended image 335 showing gradations of blend between the synthetic vision image 300 of FIG. 3A and the video image 370 of FIG. 3C, where FIG. 3C illustrates a video image 370 of an outside environment including an obstruction such as fog or cloud according to one embodiment of the invention. In some embodiments, the system architecture 10 can display the video image 370 from data captured by the at least one physical image sensor 65 sensitive to detectable energy 80. In some embodiments, the video image 370 can comprise a video image display data 380 displayed over a background 390, and at least one blended instrument display 375 blended with the video image display data 380 displayed and the background 390. Further, information from at least one of the position/altitude processor 40, at least one terrain/water database 22 and/or feature database 24 can be processed by the system architecture 10 using a synthetic image generator 30 to produce a synthetic image 300 based at least in part on one or more GPS signals 70 and/or external forces 75. In some embodiments, the synthetic image 300 can comprise a synthetic environment image 315 depicting a representation of the outside world with at least one blended instrument display 310. In some embodiments, the blended vision processor 35 can receive and process the synthetic image 300 from the synthetic image generator 30, and the video image 370 from the video capture and processor 45 to produce the blended image 335. Therefore, the blended image 335 can comprise a blend of the synthetic image 300 and the video image 370. Further, in some embodiments, the blended image 335 can comprise a blended image region 345 at least partially surrounded by a synthetic image portion 350 derived from the synthetic environment image 315. In some embodiments, the blended image region 345 can comprise the at least one blended instrument display 340 derived from blending the blended video image display data 380 with either the at least one blended instrument display 310 or the at least one blended instrument display 375.

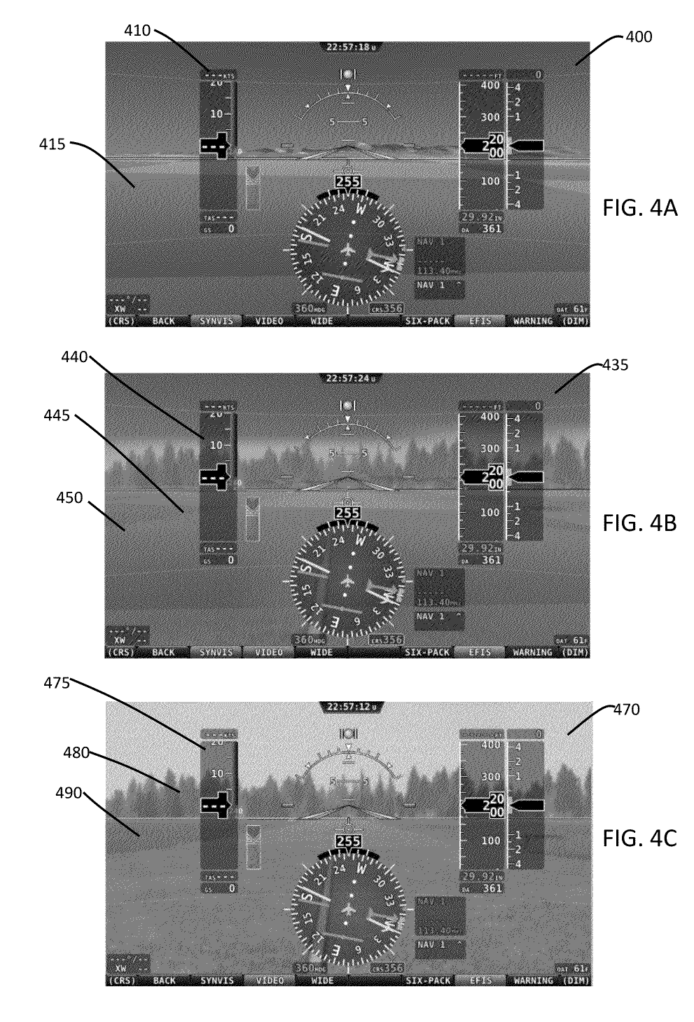

FIG. 4A illustrates a synthetic vision image 400 according to one embodiment of the invention. Further, FIG. 4B illustrates a blended image 435 showing gradations of blend between the synthetic vision image 400 of FIG. 4A and the video image 470 of FIG. 4C, where FIG. 4C illustrates a video image 470 of an outside environment of an airfield according to one embodiment of the invention. In some embodiments, the system architecture 10 can display the video image 470 from data captured by the at least one physical image sensor 65 sensitive to detectable energy 80. In some embodiments, the video image 470 can comprise a video image display data 480 displayed over a background 490, and at least one blended instrument display 475 blended with the video image display data 480 displayed and the background 490. Further, in some embodiments, information from at least one of the position/altitude processor 40, at least one terrain/water database 22 and/or feature database 24 can be processed by the system architecture 10 using a synthetic image generator 30 to produce a synthetic image 400 based at least in part on one or more GPS signals 70 and/or external forces 75. In some embodiments, the synthetic image 400 can comprise a synthetic environment image 415 depicting a representation of the outside world with at least one blended instrument display 410. In some embodiments of the invention, the blended vision processor 35 can receive and process the synthetic image 400 from the synthetic image generator 30, and the video image 470 from the video capture and processor 45 to produce the blended image 435. Therefore, the blended image 435 can comprise a blend of the synthetic image 400 and the video image 470. Further, in some embodiments, the blended image 435 can comprise a blended image region 445 at least partially surrounded by a synthetic image portion 450 derived from the synthetic environment image 415. In some embodiments, the blended image region 445 can comprise the at least one blended instrument display 440 derived from blending the blended video image display data 480 with either the at least one blended instrument display 410 or the at least one blended instrument display 475.

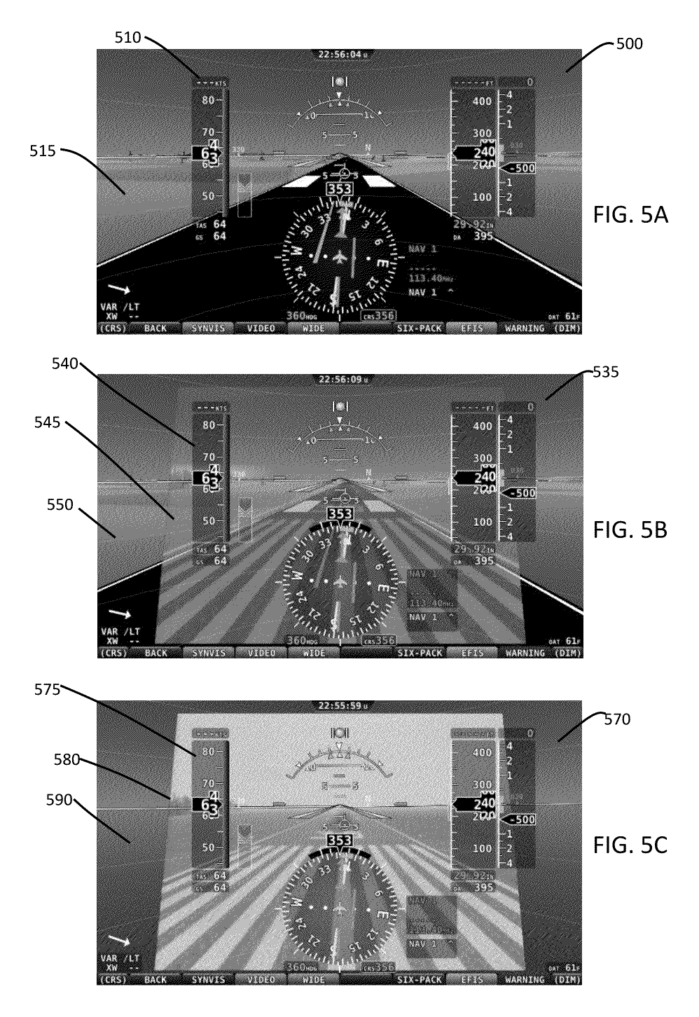

FIG. 5A illustrates a synthetic vision image 500 according to one embodiment of the invention. Further, FIG. 5B illustrates a blended image 535 showing gradations of blend between the synthetic vision image 500 of FIG. 5A and the video image 570 of FIG. 5C, where FIG. 5C illustrates a video image 570 of an outside environment including an airfield runway according to one embodiment of the invention. In some embodiments, the system architecture 10 can display the video image 570 from data captured by the at least one physical image sensor 65 sensitive to detectable energy 80. In some embodiments, the video image 570 can comprise a video image display data 580 displayed over a background 590, and at least one blended instrument display 575 blended with the video image display data 580 displayed and the background 590. Further, in some embodiments, information from at least one of the position/altitude processor 40, at least one terrain/water database 22 and/or feature database 24 can be processed by the system architecture 10 using a synthetic image generator 30 to produce a synthetic image 500 based at least in part on one or more GPS signals 70 and/or external forces 75. In some embodiments of the invention, the synthetic image 500 can comprise a synthetic environment image 515 depicting a representation of the outside world with at least one blended instrument display 510. In some embodiments, the blended vision processor 35 can receive and process the synthetic image 500 from the synthetic image generator 30, and the video image 570 from the video capture and processor 45 to produce the blended image 535. Therefore, the blended image 535 can comprise a blend of the synthetic image 500 and the video image 570. In some embodiments, the blended image 535 can comprise a blended image region 545 at least partially surrounded by a synthetic image portion 550 derived from the synthetic environment image 515. In some embodiments of the invention, the blended image region 545 can comprise the at least one blended instrument display 540 derived from blending the blended video image display data 580 with either the at least one blended instrument display 510 or the at least one blended instrument display 575.

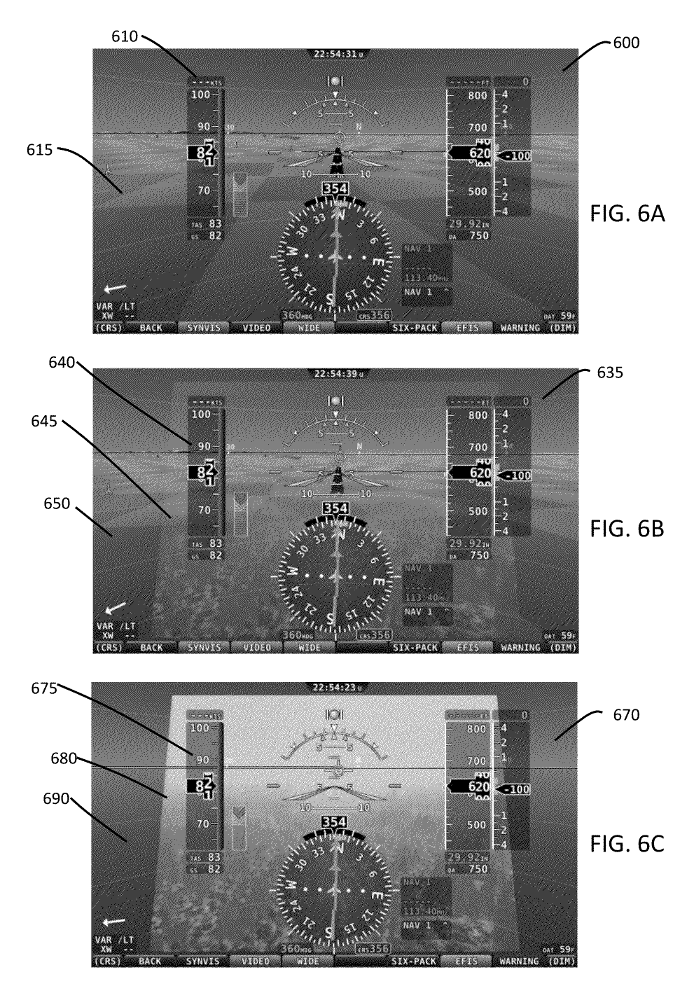

FIG. 6A illustrates a synthetic vision image 600 according to one embodiment of the invention. Further, FIG. 6B illustrates a blended image 635 showing gradations of blend between the synthetic vision image 600 of FIG. 6A and the video image 670 of FIG. 6C, where FIG. 6C illustrates a video image 670 according to one embodiment of the invention. In some embodiments, the system architecture 10 can display the video image 670 from data captured by the at least one physical image sensor 65 sensitive to detectable energy 80. Some embodiments include the video image 670 that can comprise a video image display data 680 displayed over a background 690, and at least one blended instrument display 675 blended with the video image display data 680 displayed and the background 690. Further, in some embodiments, information from at least one of the position/altitude processor 40, at least one terrain/water database 22 and/or feature database 24 can be processed by the system architecture 10 using a synthetic image generator 30 to produce a synthetic image 600 based at least in part on one or more GPS signals 70 and/or external forces 75. In some embodiments, the synthetic image 600 can comprise a synthetic environment image 615 depicting a representation of the outside world with at least one blended instrument display 610. In some embodiments, the blended vision processor 35 can receive and process the synthetic image 600 from the synthetic image generator 30, and the video image 670 from the video capture and processor 45 to produce the blended image 635. Therefore, in some embodiments, the blended image 635 can comprise a blend of the synthetic image 600 and the video image 670. Further, in some embodiments, the blended image 635 can comprise a blended image region 645 at least partially surrounded by a synthetic image portion 650 derived from the synthetic environment image 615. In some embodiments, the blended image region 645 can comprise the at least one blended instrument display 640 derived from blending the blended video image display data 680 with either the at least one blended instrument display 610 or the at least one blended instrument display 675.

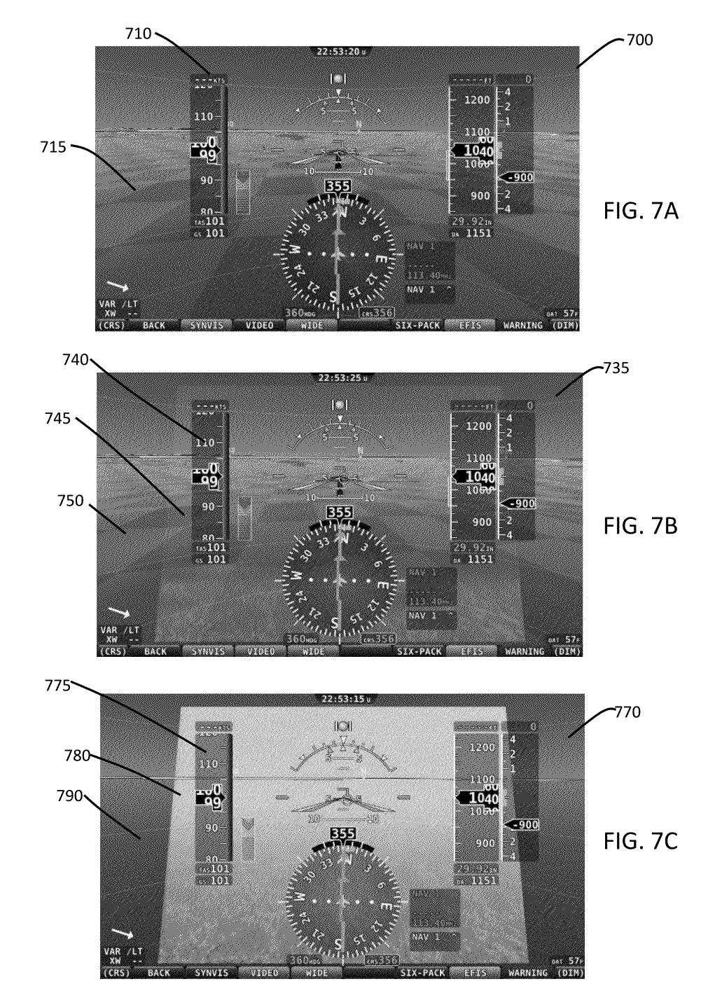

FIG. 7A illustrates a synthetic vision image 700 according to one embodiment of the invention. Further, FIG. 7B illustrates a blended image 735 showing gradations of blend between the synthetic vision image 700 of FIG. 7A and the video image 770 of FIG. 7C, where FIG. 7C illustrates a video image 770 of an outside environment at least partially obstructed with fog or cloud according to one embodiment of the invention. In some embodiments, the system architecture 10 can display the video image 770 from data captured by the at least one physical image sensor 65 sensitive to detectable energy 80. In some embodiments, the video image 770 can comprise a video image display data 780 displayed over a background 790, and at least one blended instrument display 775 blended with the video image display data 780 displayed and the background 790. Further, in some embodiments, information from at least one of the position/altitude processor 40, at least one terrain/water database 22 and/or feature database 24 can be processed by the system architecture 10 using a synthetic image generator 30 to produce a synthetic image 700 based at least in part on one or more GPS signals 70 and/or external forces 75. In some embodiments of the invention, the synthetic image 700 can comprise a synthetic environment image 715 depicting a representation of the outside world with at least one blended instrument display 710. In some embodiments, the blended vision processor 35 can receive and process the synthetic image 700 from the synthetic image generator 30, and the video image 770 from the video capture and processor 45 to produce the blended image 735. Therefore, in some embodiments, the blended image 735 can comprise a blend of the synthetic image 700 and the video image 770. Further, in some embodiments, the blended image 735 can comprise a blended image region 745 at least partially surrounded by a synthetic image portion 750 derived from the synthetic environment image 715. In some embodiments of the invention, the blended image region 745 can comprise the at least one blended instrument display 740 derived from blending the blended video image display data 780 with either the at least one blended instrument display 710 or the at least one blended instrument display 775.

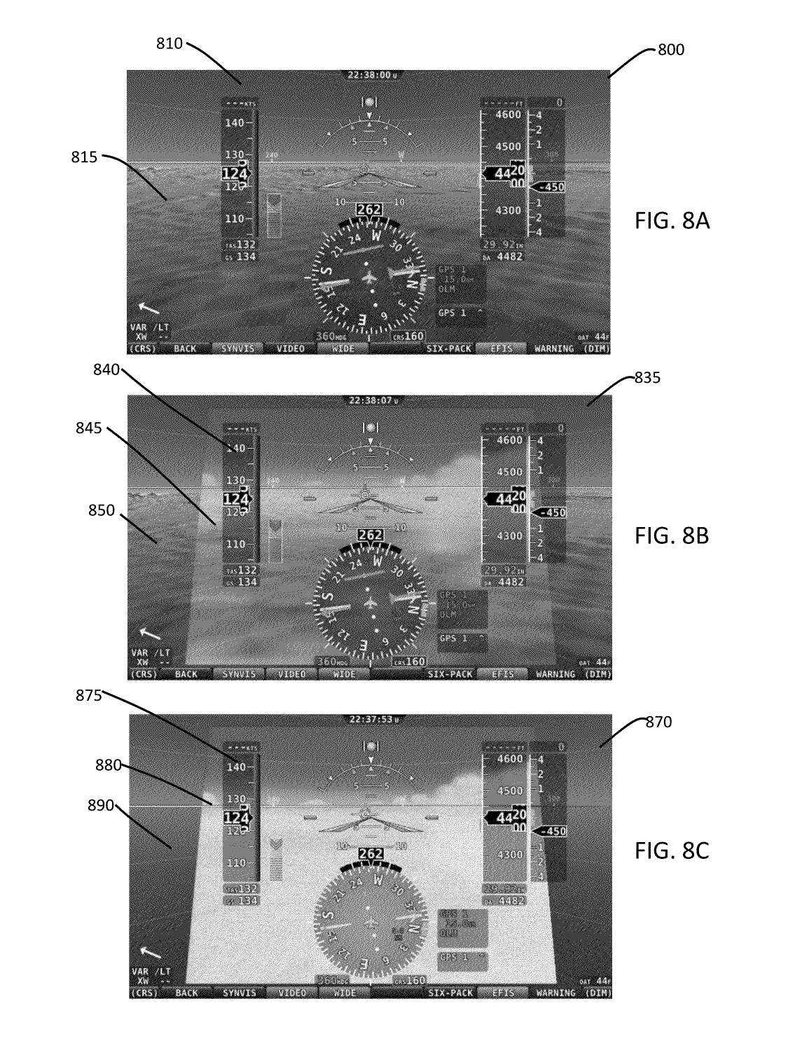

FIG. 8A illustrates a synthetic vision image 800 according to one embodiment of the invention. Further, FIG. 8B illustrates a blended image 835 showing gradations of blend between the synthetic vision image 800 of FIG. 8A and the video image 870 of FIG. 8C, where FIG. 8C illustrates a video image 870 of an outside environment including clouds according to one embodiment of the invention. In some embodiments, the system architecture 10 can display the video image 870 from data captured by the at least one physical image sensor 65 sensitive to detectable energy 80. In some embodiments, the video image 870 can comprise a video image display data 880 displayed over a background 890, and at least one blended instrument display 875 blended with the video image display data 880 displayed and the background 890. Further, in some embodiments, information from at least one of the position/altitude processor 40, at least one terrain/water database 22 and/or feature database 24 can be processed by the system architecture 10 using a synthetic image generator 30 to produce a synthetic image 800 based at least in part on one or more GPS signals 70 and/or external forces 75. In some embodiments, the synthetic image 800 can comprise a synthetic environment image 815 depicting a representation of the outside world with at least one blended instrument display 810. In some embodiments of the invention, the blended vision processor 35 can receive and process the synthetic image 800 from the synthetic image generator 30, and the video image 870 from the video capture and processor 45 to produce the blended image 835. Therefore, in some embodiments, the blended image 835 can comprise a blend of the synthetic image 800 and the video image 870. In some embodiments, the blended image 835 can comprise a blended image region 845 at least partially surrounded by a synthetic image portion 850 derived from the synthetic environment image 815. In some embodiments, the blended image region 845 can comprise the at least one blended instrument display 840 derived from blending the blended video image display data 880 with either the at least one blended instrument display 810 or the at least one blended instrument display 875.

In some embodiments, the invention can also be embodied as computer readable code on a computer readable medium. The computer readable medium can be any data storage device that can store data, which can thereafter be read by a computer system. Examples of the computer readable medium can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network so that the computer readable code can be stored and executed in a distributed fashion. For example, in some embodiments, one or more components of the system architecture can be tethered to send and/or receive data through a local area network (LAN). In some further embodiments, one or more components of the system architecture can be tethered to send or receive data through an internet. In some embodiments, at least one software module (e.g., one or more enterprise applications) and one or more components of the system architecture 10 can be configured to be coupled for communication over a network. In some embodiments, one or more components of the network can include one or more resources for data storage, including any other form of computer readable media beyond the media for storing information and including any form of computer readable media for communicating information from one electronic device to another electronic device.

While one embodiment can be implemented in fully functioning computers and computer systems various embodiments are capable of being distributed as a computing product in a variety of forms and are capable of being applied regardless of the particular type of machine or computer-readable media used to actually effect the distribution. For example, in some embodiments, at least some aspects disclosed can be embodied, at least in part, in software. That is, the techniques can be carried out in a computer system or other data processing system in response to its processors (such as a microprocessor) executing sequences of instructions contained in a memory, such as ROM, volatile RAM, non-volatile memory, cache or a remote storage device. Further, in some embodiments, the above-described methods and reports implemented with system architecture can store analytical models and other data on computer-readable storage media. With the above embodiments in mind, it should be understood that the invention can employ various computer-implemented operations involving data stored in computer systems (such as for example, system). These operations are those requiring physical manipulation of physical quantities. Usually, though not necessarily, these quantities take the form of electrical or magnetic signals capable of being stored, transferred, combined, compared and otherwise manipulated. Moreover, in some embodiments, the instructions can also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

Any of the operations described herein that form part of the invention are useful machine operations. The processes and method steps performed within the system architecture cannot be performed in the human mind or derived by a human using pen and paper, but require machine operations to process input data to useful output data. For example, the processes and method steps performed with the system architecture can include a computer-implemented method comprising steps performed by at least one processor. The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention also relates to a device or an apparatus for performing these operations. The apparatus can be specially constructed for the required purpose, such as a special purpose computer system. When defined as a special purpose computer system, the computer system can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An image blending display system comprising:
at least one sensor interface configured to receive position information from at least one physical position sensor;
at least one image stream interface configured to receive image data from at least one physical image sensor;
a non-transitory computer-readable medium in data communication with at least one processor, the non-transitory computer-readable medium including a database system;
one or more processors coupled to the database system and configured to process information from the non-transitory computer-readable medium and from at least one other information source,
the at least one other information source comprising the at least one sensor interface and the at least one image stream interface; and
a blended vision processor;
a synthetic image generator in communication with the database system, the at least one sensor interface, and the blended vision processor, the synthetic image generator configured to deliver at least one synthetic image to the blended vision processor; and
a video capture and processor in communication with the blended vision processor, the blended vision processor configured to image process at least one synthetic image delivered by the synthetic image processor and at least one image from the video capture and processor to produce at least one blended image for the display based at least in part on the at least one synthetic image and the at least one image.

2. The system of claim 1, wherein the database system comprises a terrain/water database.

3. The system of claim 1, wherein the database system comprises a feature database.

4. The system of claim 1, wherein the at least one physical position sensor comprises a GPS sensor.

5. The system of claim 1, wherein the at least one physical position sensor comprises at least one of an altitude sensor, a speed sensor, and a heading sensor.

6. The system of claim 1, wherein the at least one physical image sensor comprises a physical optical sensor.

7. The system of claim 1, wherein the at least one physical image sensor comprises a camera.

8. The system of claim 1, wherein the position information is derived from at least one of a GPS signal and an external force.

9. The system of claim 1, wherein the video capture and processor is configured to deliver image data based at least in part on detectable energy.

10. The system of claim 1, wherein the blended video processor is coupled to a plurality of user displays.

11. The system of claim 1, wherein the blended vision processor is configured to process image data by calculation of a destination color, D, where D is computed as (1-A)×S₁+A×S₂, where S₁ and S₂ are given source colors and A is a blending factor.

12. An image blending display system comprising:
a non-transitory computer-readable medium in data communication with at least one processor, the non-transitory computer-readable medium including software instructions comprising a synthetic vision and video image blending system and method; and
one or more processors configured to execute the software instructions to:
couple to at least one sensor interface and to receive positional information from at least one physical sensor;
couple to at least one image stream interface and to receive image data from at least one physical image sensor;
couple to and process information from a database system and from at least one other information source, the at least one other information source comprising the at least one sensor interface and the at least one image stream interface; and
process at least one synthetic image using a synthetic image generator, the at least one synthetic image generator in communication with the database system, the at least one sensor interface, and a blended vision processor; and
process a delivery of at least one synthetic image to the blended vision processor;
using a video capture and processor video capture, process at least one image from the and at least one image stream interface, the video capture and processor video capture communicatively coupled to the blended vision processor; and
using the blended vision processor, process and display at least one blended image based at least in part on the at least one image and the at least one synthetic image.

13. The system of claim 12, wherein the blended vision processor processes image data by calculation of a destination color, D, where D is computed as (1-A)×S₁+A×S₂, where S₁ and S₂ are given source colors and A is a blending factor.

14. The system of claim 12, wherein the blended image comprises destination color, D, where D is computed as (1-A)×S₁+A×S₂, where S₁ and S₂ are given source colors and A is a blending factor.

15. The system of claim 12, wherein the database system comprises at least one of a terrain/water database and a feature database.

16. The system of claim 12, wherein the at least one physical sensor comprises a GPS sensor

17. The system of claim 12, wherein the at least one physical sensor comprises at least one of an altitude sensor, a speed sensor, and a heading sensor.

18. The system of claim 12, wherein the at least one physical image sensor comprises a camera.

19. The system of claim 12, wherein the position information is derived from at least one of a GPS signal and an external force; and
wherein the video capture and processor processes the at least one image based at least in part on detectable energy.

20. A computer-implemented method of displaying a blended image comprising:
providing a non-transitory computer-readable medium in data communication with at least one processor, the non-transitory computer-readable medium including software instructions comprising a synthetic vision and video image blending system and method; and
providing one or more processors configured to execute the steps of the method comprising:
coupling to at least one sensor interface and receiving positional information from at least one physical sensor;
coupling to at least one image stream interface and receiving image data from at least one physical image sensor;
coupling to and processing information from a database system and from at least one other information source, the at least one other information source comprising the at least one sensor interface and the at least one image stream interface; and
processing at least one synthetic image using a synthetic image generator, the at least one synthetic image generator in communication with the database system, the at least one sensor interface, and a blended vision processor; and
processing a delivery of at least one synthetic image to the blended vision processor;
using a video capture and processor video capture, processing at least one image from the and at least one image stream interface, the video capture and processor video capture communicatively coupled to the blended vision processor; and
using the blended vision processor, processing and displaying at least one blended image based at least in part on the at least one image and the at least one synthetic image, the at least one blended image comprising a destination color, D, where D is computed as (1-A)×S₁+A×S₂, where S₁ and S₂ are given source colors and A is a blending factor.
